(19) United States
(12) Patent Application Publication
(10) Pub. No.: US 2026/0002404 A1
(43) Pub. Date: Jan. 1, 2026

(54) THERMALLY BROKEN FENESTRATION SYSTEMS

(71) Applicant: Arconic Technologies LLC, Pittsburgh, PA (US)

(72) Inventor: Michael David MITCHELL, Woodstock, GA (US)

(73) Assignee: Arconic Technologies LLC, Pittsburgh, PA (US)

(21) Appl. No.: 19/094,595

(22) Filed: Mar. 28, 2025

Related U.S. Application Data
(60) Provisional application No. 63/664,640, filed on Jun. 26, 2024.

(51) Int. Cl. E06B 1/16; E06B 1/36; E06B 3/263

(52) U.S. Cl. CPC E06B 1/16; E06B 1/36; E06B 3/263

(57) ABSTRACT

A fenestration is disclosed comprising a plurality of frame members. At least one of the frame members comprises an exterior extrusion, an interior extrusion, a central extrusion intermediate the interior extrusion and the exterior extrusion, and a thermal break to couple the exterior extrusion and the central extrusion.

### BACKGROUND

Aluminum stands out as a favored choice in structural members for windows, doors and other fenestration products because of its structural longevity and its high resistance against corrosion, deflection and wind load. This outstanding material is lightweight and is quick and simple to extrude, machine and fabricate into virtually any form. Optimizing thermal performance in fenestration systems contributes to energy efficiency and helps reduce associated heating and cooling costs. One disadvantage to the use of aluminum in windows and doors is that it is a highly conductive material. Conduction is heat transfer which can be controlled by the addition of low-conductance thermal barrier materials. When a thermal barrier process is completed, there is no aluminum contact from the exterior to interior. Thus, transfer of heat is interrupted, resulting in an energy-efficient, insulating thermal barrier.

One notable phenomenon that has garnered attention in the field of aluminum door construction is the bimetallic effect. Conventional storefront aluminum doors include opposing exterior and interior extrusion members that are coupled via one or more thermal breaks. Due to convection and thermal radiation from the sun or warmer ambient temperature in contrast to indoor temperatures, the exterior extrusion can be heated to an elevated temperature, such as 170° F., which causes the exterior extrusion to expand and bow relative to the interior extrusion, which is generally maintained at room temperature due to the thermal break(s). This temperature and resulting differential change in length between the exterior and interior extrusions is referred to as the bi-metallic effect.

It has been found that interferences between the doors/windows and their respective frames can occur due to this effect. For example, with respect to sliding doors, it has been found that a bowed exterior extrusion oftentimes abuts against the frame of the door when a user attempts to slide the door open or closed, making it difficult to move the door between an open state and a closed state.

Accordingly, assemblies and systems that help reduce or prevent the bi-metallic effect in fenestration systems are desirable.

### SUMMARY OF THE DISCLOSURE

Various details of the present disclosure are hereinafter summarized to provide a basic understanding. This summary is not an extensive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

Embodiments disclosed herein include a fenestration that includes a plurality of frame members, at least one of the frame members comprising an exterior extrusion, an interior extrusion, a central extrusion intermediate the interior extrusion and the exterior extrusion, and a thermal break to couple the exterior extrusion and the central extrusion. In a further embodiment of the fenestration, the thermal break is a first thermal break and the fenestration further comprises a second thermal break to couple the interior extrusion to the central extrusion. In another further embodiment of the fenestration, the central extrusion comprises a tubular extrusion. In another further embodiment of the fenestration, the exterior extrusion comprises an I-shaped extrusion. In another further embodiment, the fenestration includes an insulator positioned between the exterior extrusion and the central extrusion.

Embodiments disclosed herein may further include a fenestration that includes a plurality of frame members, at least one of the frame members comprising an exterior extrusion defining a first clip pocket, an interior extrusion, a central extrusion intermediate the interior and exterior extrusions and defining a second clip pocket, and a clip positionable in the first and second clip pockets to couple the exterior extrusion and the central extrusion and provide a thermal break between the exterior extrusion and the central extrusion. In a further embodiment, the interior extrusion defines a third clip pocket and the central extrusion further defines a fourth clip pocket, wherein the at least one of the frame members further comprises a second clip positionable in the third and the fourth clip pockets to couple the interior extrusion and the central extrusion and provide a thermal break between the exterior extrusion and the central extrusion. In another further embodiment, the central extrusion comprises a tubular extrusion. In another further embodiment, wherein the exterior extrusion comprises an I-shaped extrusion. In another further embodiment, the exterior extrusion further defines a first recess, the central extrusion further defines a second recess, the first clip defines a body, the first recess, the second recess, and the body define a pocket based on the exterior extrusion being coupled to the central extrusion via the first clip, and the at least one of the frame member further comprises a thermal barrier positioned in the pocket. In another further embodiment, the fenestration is a door. In another further embodiment, the fenestration is a window. In another further embodiment, the fenestration includes an insulator positioned between the exterior extrusion and the central extrusion. In another further embodiment, the insulator comprises an insulating foam. In another further embodiment, the insulator comprises polyurethane.

Embodiments disclosed herein may further include a method of preparing a frame member for a fenestration, the method including coupling an exterior extrusion to a central extrusion by positioning a first portion of a first clip into a clip pocket of the exterior extrusion, and positioning a second portion of the first clip into a first clip pocket of the central extrusion. The method further including coupling an interior extrusion to the central extrusion by positioning a first portion of a second clip into a clip pocket of the interior extrusion, and positioning a second portion of the second clip into a second clip pocket of the central extrusion. In a further embodiment, the method includes comprising positioning an insulator between the exterior extrusion and the central extrusion. In another further embodiment, positioning the insulator between the exterior extrusion and the central extrusion comprises attaching the insulator to at least one of the exterior extrusion and the central extrusion with an adhesive. In another further embodiment, positioning the insulator between the exterior extrusion and the central extrusion comprises sliding the insulator between the coupled exterior extrusion and central extrusion. In another further embodiment, positioning the insulator between the exterior extrusion and the central extrusion comprises spraying an expanding foam between the coupled exterior extrusion and central extrusion.

### BRIEF DESCRIPTION OF THE DRAWINGS

The following figures are included to illustrate certain aspects of the present disclosure, and should not be viewed as exclusive embodiments. The subject matter disclosed is capable of considerable modifications, alterations, combinations, and equivalents in form and function, without departing from the scope of this disclosure.

FIG. 1 is an isometric view of a door system, according to at least one aspect of the present disclosure.

FIG. 2 is a cross-sectional side view of a prior art frame member for a door.

FIG. 3 is a cross-sectional side view of an example frame member that incorporates one or more aspects of the present disclosure.

FIG. 3A is an enlarged, detailed view of a retainer clip and a thermal barrier of FIG. 3, according to at least one aspect of the present disclosure.

FIG. 3B is another enlarged, detailed view of a retainer clip and a thermal barrier of FIG. 3, according to at least one aspect of the present disclosure.

FIG. 4 is a top-down view of the doors of FIG. 1, according to at least one aspect of the present disclosure.

FIG. 5 is a method for preparing a frame member for a fenestration, according to at least one aspect of the present disclosure.

FIGS. 5A-5C are schematic diagrams showing progressive steps of assembling the frame member of the present disclosure and in accordance with the method of FIG. 5, according to at least one aspect of the present disclosure.

FIG. 5D is an exploded view of the frame member after Step 5 of the example implementation of the method, according to at least one aspect of the present disclosure.

### DETAILED DESCRIPTION

The present disclosure is related to door systems and, more particularly, to frame members of doors for inhibiting the bi-metallic effect.

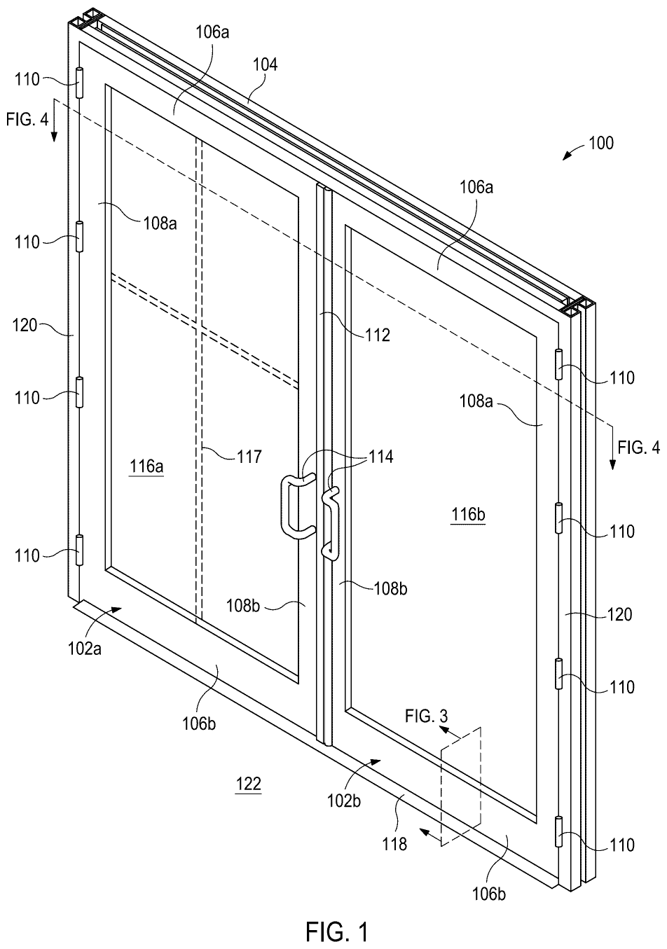

FIG. 1 is an isometric view of a door system 100 that may incorporate one or more principles of the present disclosure. The illustrated door system 100 (hereafter “the system 100”) comprises a framed building assembly that may form part of a commercial building application. The principles and concepts described herein, however, are equally applicable to residential building applications. Moreover, the principles of the present disclosure may alternatively be applied to other types of framed building assemblies including, but not limited to, window vents, window frames, curtain walls, storefronts, or any combination thereof. Accordingly, while the following discussion is directed to a framed door system, other types of framed assemblies may equally incorporate the presently disclosed features.

As illustrated, the system 100 comprises a double-door assembly that includes a first door 102a and a second door 102b pivotably mounted to a doorframe 104. While two doors 102a,b are included in the system 100, the principles of the present disclosure may be equally applicable to systems that include only one door or more than two doors. Moreover, while the two doors 102a,b are depicted as pivotable, swing-type doors, the principles of the present disclosure are also applicable to sliding doors. The doorframe 104 may be installed in a commercial or residential building (not shown) and define an entryway that is occluded when the doors 102a,b close. Each door 102a,b may include a plurality of frame members, such as a top rail 106a, a bottom rail 106b, and opposing side and center stiles 108a and 108b that extend between the top and bottom rails 106a,b. The ends of each rail 106a,b are joined to the adjacent stiles 108a,b at generally orthogonal corner joints.

The rails 106a,b and the stiles 108a,b may be made of a variety of rigid materials including, but not limited to, aluminum, rolled sheet metal, a polymer, a composite material (e.g., fiberglass, carbon fiber, etc.), or any combination thereof. In the illustrated embodiment, the side stiles 108a are pivotably mounted to the doorframe 104 on opposite sides with one or more hinges 110. The center stiles 108b meet at the middle of the system 100 when the doors 102a,b closed and generally define an elongated clearance gap (occluded) between adjacent facing vertical edges (ends) of the center stiles 108b. In at least one embodiment, an applied cover 112 may be removably (or permanently) attached to one or both of the center stiles 108b on the interior or the exterior of the system 100. The applied cover 112 may be configured to extend across and occlude the clearance gap between the center stiles 108b.

In some embodiments, conventional door hardware, such as opposing door handles 114 and locks (not shown) may be installed on one or both of the center stiles 108b to help facilitate opening and locking of the doors 102a,b.

The rails 106a,b and the stiles 108a,b cooperatively surround and otherwise “frame” first and second center panels 116a and 116b, alternately referred to as “infill” panels. While one center panel 116a,b is included in each door 102a,b, more than one may be employed. In some embodiments, the center panels 116a,b may each comprise glass lites and, in at least one embodiment, may comprise double paned glass including air, an inert gas, and/or a plastic film(s) between adjacent panes to control transmission of thermal energy. In other embodiments, however, the center panels 116a,b may alternatively comprise other types of infills such as, but not limited to, a glazing panel, polycarbonate, or another clear, translucent, tinted, or opaque panel. Moreover, in other embodiments, one or both of the center panels 116a,b may include horizontal and/or vertical grids 117 (shown in dashed lines) that divide the center panels 116a,b into multiple panel sections.

The system 100 may further include a threshold 118, also referred to as a “sill”. The threshold 118 may extend between the opposing vertical jambs 120 of the doorframe 104 at the bottom. In some embodiments, the threshold 118 may form a bottom part of the doorframe 104. In other embodiments, however, the threshold 118 may comprise a separate component secured to an underlying surface 122. The underlying surface 122 may comprise, for example, a substantially flat and/or horizontal surface, such as a floor or the ground. The underlying surface 122, however, need not be horizontal, but could alternatively be slanted or angled, such as slanted or angled away from the system 100.

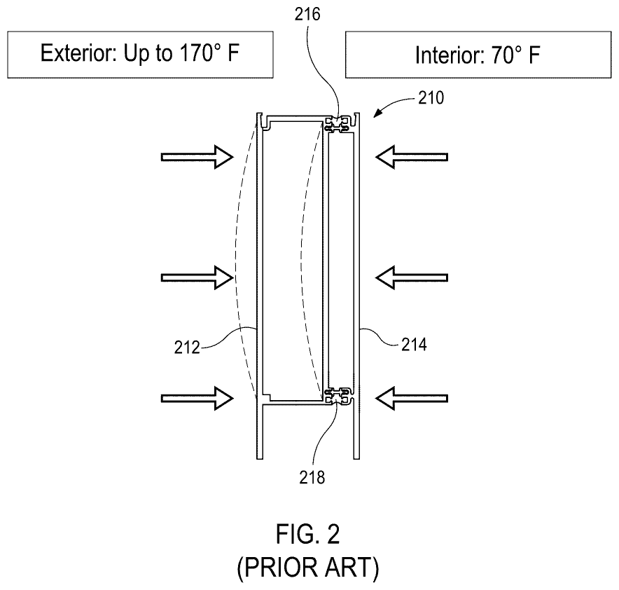

FIG. 2 is a cross-sectional side view of a prior art frame member 210 for a door. The frame member 210 could form part of either of the doors 102a,b of FIG. 1. More specifically, the extrusion assembly 210 may represent any of the described frame members; e.g., the top or bottom rails 106a,b and/or the stiles 108a,b. As illustrated, the extrusion assembly 210 includes a first or “exterior” extrusion 212 interconnected to a second or “interior” extrusion 214. The exterior extrusion 212 comprises a generally tubular structure, while the interior extrusion 214 comprises a generally I-shaped structure. The exterior and interior extrusions 212, 214 are coupled together using a first thermal break 216 and a second thermal break 218.

The exterior extrusion 212 is generally exposed to the outside environment, and the interior extrusion 214 is generally exposed to the interior environment. Due to convection and thermal radiation from the sun, the exterior extrusion 212 may be heated to an elevated temperature, such as 170° F., causing the exterior extrusion 212 to expand and bow (shown with dashed lines) relative to the interior extrusion 214. Due to the first thermal break 216 and the second thermal break 218, heat transfer from the exterior extrusion 212 to the interior extrusion 214 is substantially interrupted. Accordingly, the interior extrusion 214 is maintained at room temperature, such as 70° F., and therefore maintains a constant length. As mentioned above, this temperature difference between the exterior extrusion 212 and interior extrusion 214, and resulting differential change in length therebetween, is referred to as a bi-metallic effect.

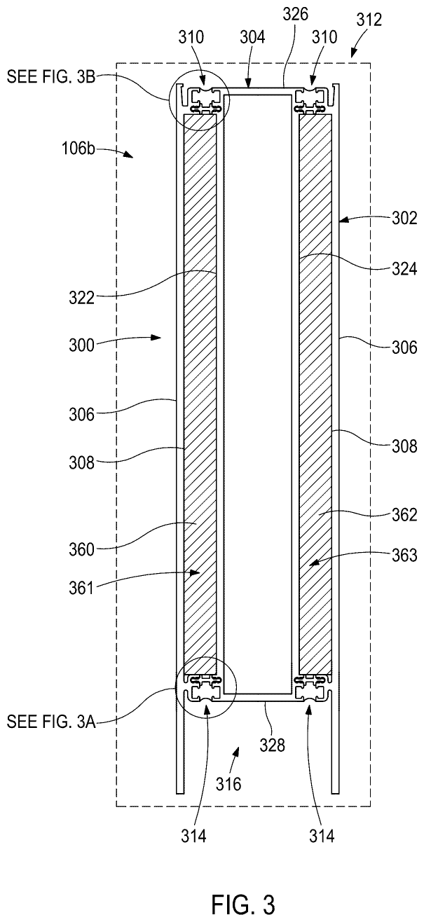

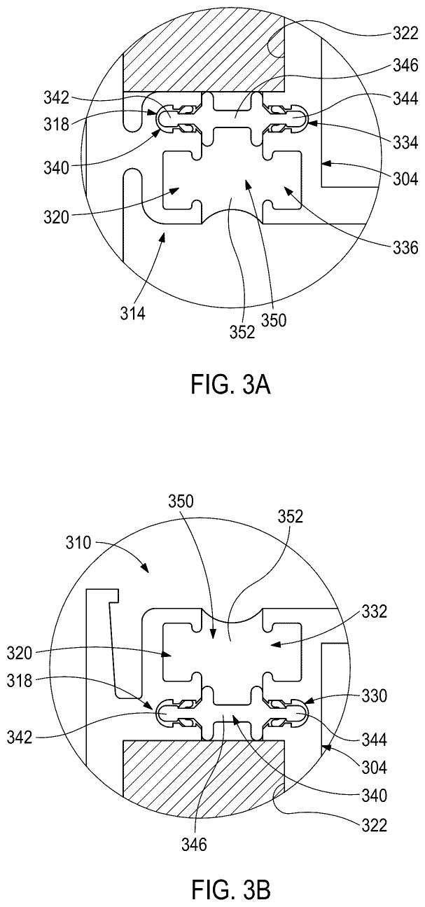

Referring now to FIG. 3, illustrated is a cross-sectional side view of an example frame member that incorporates one or more aspects of the present disclosure. More specifically, FIG. 3 is a cross-sectional side view of the bottom rail 106b of the door 102b (FIG. 1), as indicated in the lines provided in FIG. 1. While the following discussion is directed to the bottom rail 106b, the principles of the present disclosure are equally applicable to any of the frame members of the doors 102a,b (FIG. 1).

As illustrated, the bottom rail 106b comprises an exterior extrusion 300 to be generally exposed to the outside environment, an interior extrusion 302 to be exposed to the inside (ambient) environment, and a central extrusion 304 intermediate (interposing) the exterior extrusion 300 and the interior extrusion 302. In one aspect, the exterior extrusion 300 and the interior extrusion 302 are both made of aluminum. In one aspect, the central extrusion 304 may be made of aluminum. In other aspects, the central extrusion 304 may be made of other materials or alloys that exhibit a lower thermal conductivity when compared to aluminum such that the central extrusion 304 mitigates thermal conduction between the exterior extrusion 300 and the interior extrusion 302. Example materials for the central extrusion 304 include, but are not limited to, brass, titanium, nickel, copper, zirconium, beryllium, a polymer (e.g., polyurethane), alloys thereof, or any combination thereof.

In some embodiments, as illustrated, the exterior extrusion 300 and the interior extrusion 302 both define I-shaped profiles that include an exterior surface 306 facing away from the central extrusion 304 and an interior surface 308 facing toward the central extrusion 304. The exterior extrusion 300 and the interior extrusion 302 each further provide or define a first arm 310 extending from the interior surface 308 toward the central extrusion 304 at or near a top end 312 of the bottom rail 106b and a second arm 314 extending from the interior surface 308 toward the central extrusion 304 at or near a bottom end 316 of the bottom rail 106b.

Referring briefly to FIGS. 3A and 3B, enlarged views of the bottom end 316 and the top end 312, respectively, are depicted, as indicated in FIG. 3. As illustrated, the first arms 310 (FIG. 3B) and the second arms 314 (FIG. 3A) each define a clip pocket 318 and a recess 320. With respect to the first arms 310, the recesses 320 are closer to the top end 312 of the bottom rail 106b than the clip pockets 318. With respect to the second arms 314, the recesses 320 are closer to the bottom end 316 of the bottom rail 106b than the clip pockets 318.

Referring again to FIG. 3, the central extrusion 304 defines a tubular, rectangular profile that includes an exterior surface 322 to confront the inner surface 308 of the exterior extrusion 300, an interior surface 324 to confront the interior surface 308 of the interior extrusion 302, a top surface 326, and a bottom surface 328. With reference to FIGS. 3A and 3B, the exterior surface 322 and interior surface 324 (FIG. 3) of the central extrusion 304 define first clip pockets 330 (FIG. 3B) and first recesses 332 (FIG. 3B) that align with the clip pockets 318 and the recesses 320 of the first arms 310, respectively. The exterior surface 322 and interior surface 324 of the central extrusion 304 further define second clip pockets 334 (FIG. 3A) and second recesses 336 (FIG. 3A) that align with the clip pockets 318 and the recesses 320 of the second arms 314, respectively.

The bottom rail 106b further comprises a plurality of retainer clips 340 (FIGS. 3A and 3B) to couple the exterior and interior extrusions 300, 302 to the central extrusion 304. In particular, referring to FIGS. 3A and 3B, each retainer clip 340 includes a first portion 342, a second portion 344, and a body 346 connecting the first and second portions 342, 344. The first portions 342 of the retainer clips 340 are inserted into and engaged with a clip pocket 318 in the exterior extrusion 300 or interior extrusion 302 and the second portions 344 of the retainer clips 340 are inserted into and engaged with a corresponding clip pocket 330, 334 of the central extrusion 304. In one aspect, the retainer clips 340 function as thermal breaks to prevent, or at least substantially inhibit, thermal conduction between exterior/interior extrusions 300, 302 and the central extrusion 304. In one aspect, the retainer clips 340 are substantially similar to the retainer clips described in U.S. Pat. No. 9,068,344, entitled “METHOD FOR INCORPORATING THERMAL BARRIERS INTO TUBULAR EXTRUSIONS USING RETAINER CLIPS”, filed Mar. 12, 2014, which is hereby incorporated by reference in its entirety herein.

Still referring to FIGS. 3A and 3B, in one aspect, the recesses 332, 336 defined in the central extrusion 304, the recesses 320 defined in the exterior extrusion 300 and interior extrusion 302, and the bodies 346 of the retainer clips 340 define a plurality of pockets 350 each sized to receive a thermal barrier 352 therein. In one aspect, the thermal barrier 352 comprises a polymer, such as polyurethane. In at least one aspect, the thermal barrier 352 comprises a poured and cured thermal barrier. The thermal barriers 352, in combination with the retainer clips 340, co-operatively function to couple the central extrusion 304 to the exterior/interior extrusions 300, 302 and/or co-operatively function as thermal breaks to prevent, or at least substantially inhibit, thermal conduction between exterior/interior extrusions 300, 302 and the central extrusion 304. In one aspect, the retainer clips 340 are primary thermal breaks and the thermal barriers 352 are secondary thermal breaks. In one aspect, the thermal barriers 352 are substantially similar to the thermal barriers described in U.S. Pat. No. 9,068,344, entitled “METHOD FOR INCORPORATING THERMAL BARRIERS INTO TUBULAR EXTRUSIONS USING RETAINER CLIPS”, filed Mar. 12, 2014, which was previously incorporated by reference in its entirety herein.

Referring again to FIG. 3, in some aspects, the bottom rail 106b further includes a first insulator 360 and a second insulator 362. The first insulator 360 may be positioned in a first gap 361 defined between the interior surface 308 of the exterior extrusion 300 and the exterior surface 322 of the central extrusion 304. The second insulator 362 may be positioned in a second gap 363 defined between the interior surface 308 of the interior extrusion 302 and the interior surface 324 of the central extrusion 304. The first and second insulators 360, 362 may comprise insulating layers. For example, in one aspect, the first insulator 360 and second insulator 362 may comprise an insulating foam. Alternatively, or in addition thereto, the first insulator 360 and second insulator 362 comprise pre-formed insulators that are removably slidable into the first gap 361 and second gap 363, respectively, after the exterior/interior extrusions 300, 302 have been coupled to the central extrusion 304. In one aspect, the first and second insulators 360, 362 may comprise expanding foam that is sprayed in the first and second gaps 361, 363 after the exterior/interior extrusions 300, 302 have been coupled to the central extrusion 304 via the retainer clips 340 and thermal barriers 352. In one aspect, the first insulator 360 is different than the second insulator 362. In some aspects, the bottom rail 106b does not include the first insulator 360 and/or the second insulator 362.

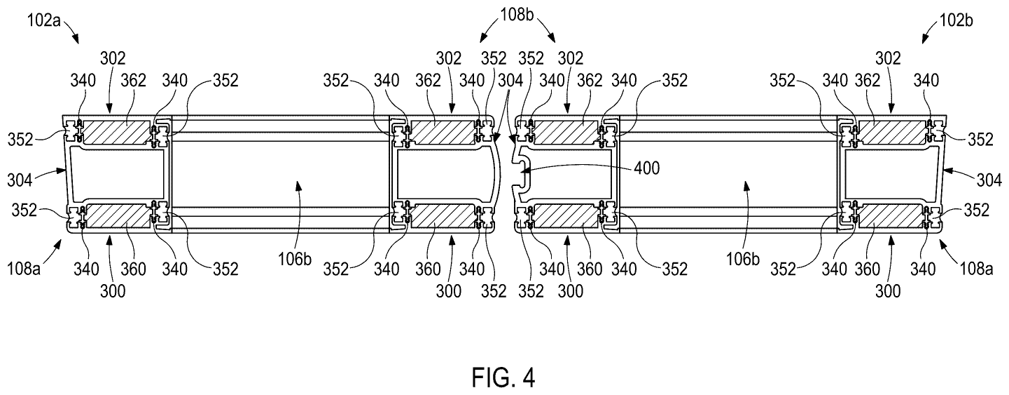

Referring now to FIG. 4, a top-down view of the doors 102a,b of FIG. 1 is provided, according to at least one aspect of the present disclosure. In the view of FIG. 4, the top rails 106a of the doors 102a,b and the doorframe 104 are omitted to illustrate the cross-sectional construction of the stiles 108a,b. As illustrated, the stiles 108a,b may have a substantially similar construction when compared to the bottom rails 106b of the doors 102b, and like numbers are used in FIG. 4 to illustrate these similarities.

In one aspect, the central extrusions 304 of the stiles 108b can define reglets, such as reglet 400 in stile 108b of the second door 102b, to receive a seal assembly therein to block water and air from migrating through the gap defined between the doors 102a,b when closed, as described in more detail in U.S. Patent Application Publication No. 2024/0026732, entitled “WATER RESISTIVE ENTRANCE DOORS FOR BUILDINGS”, filed Nov. 12, 2021, which is hereby incorporated by reference in its entirety herein. In one aspect, hardware can be stored in the central extrusions 304 of the stiles 108a,b. In one aspect, a pocket can be defined in at least one of the stiles 108a,b to receive the hardware.

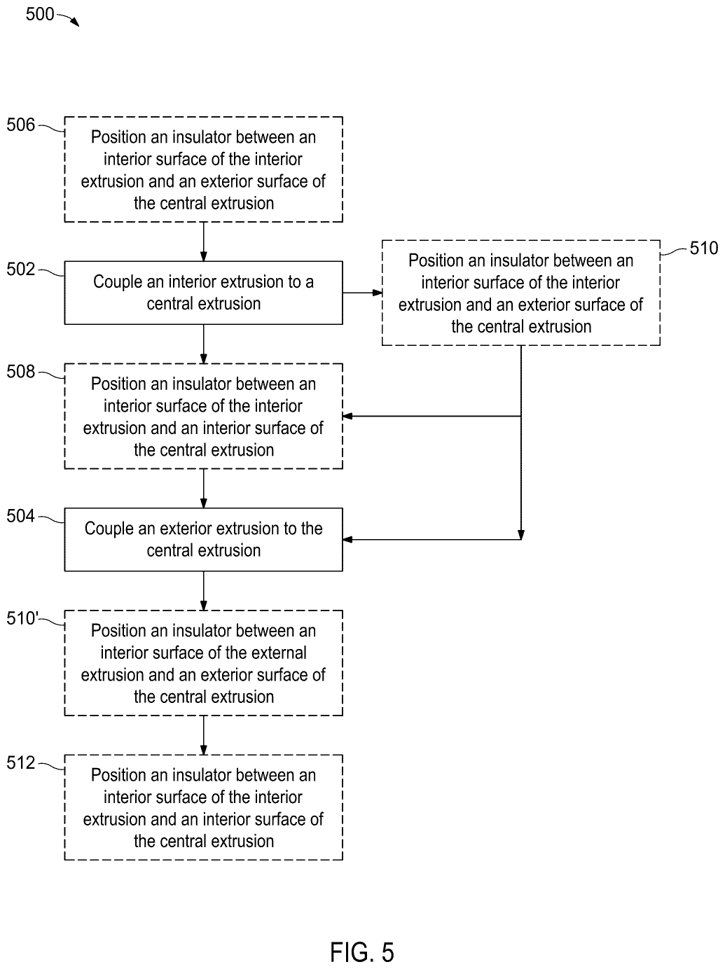

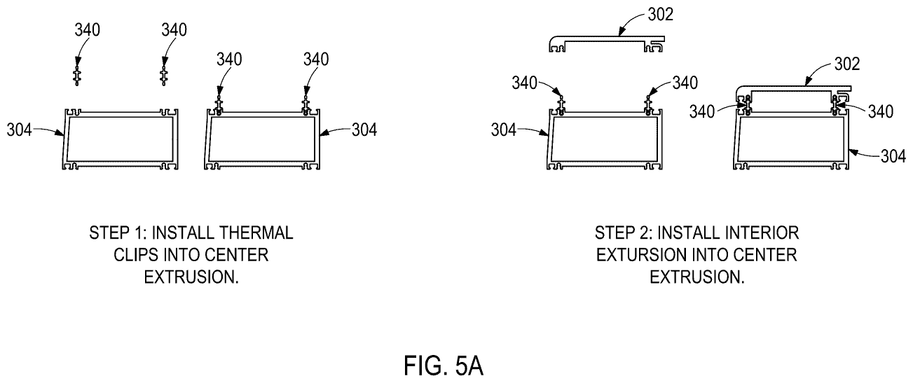

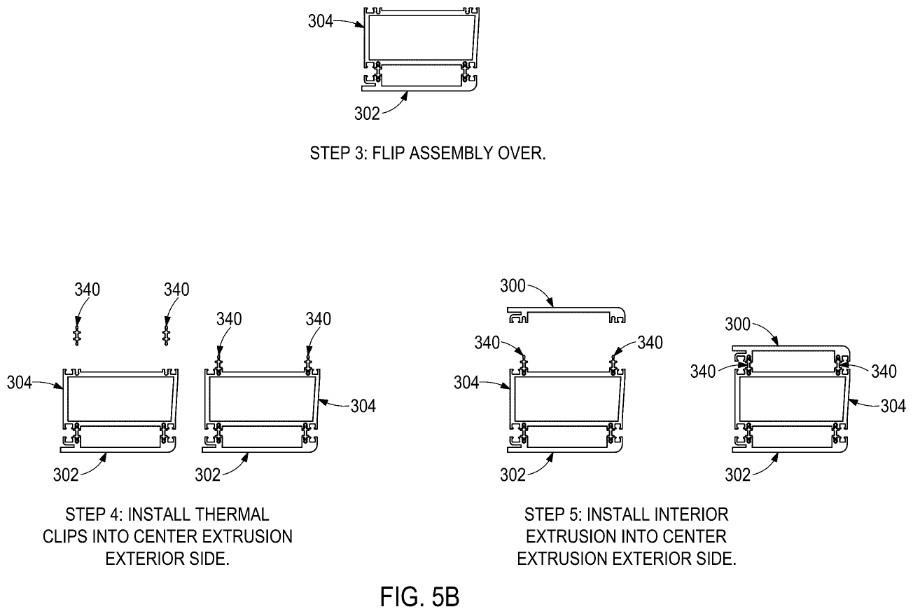

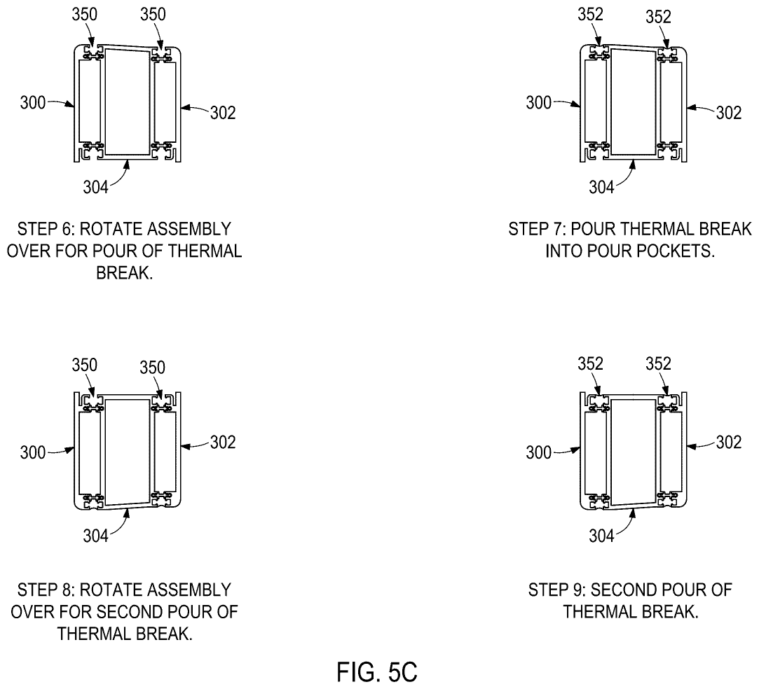

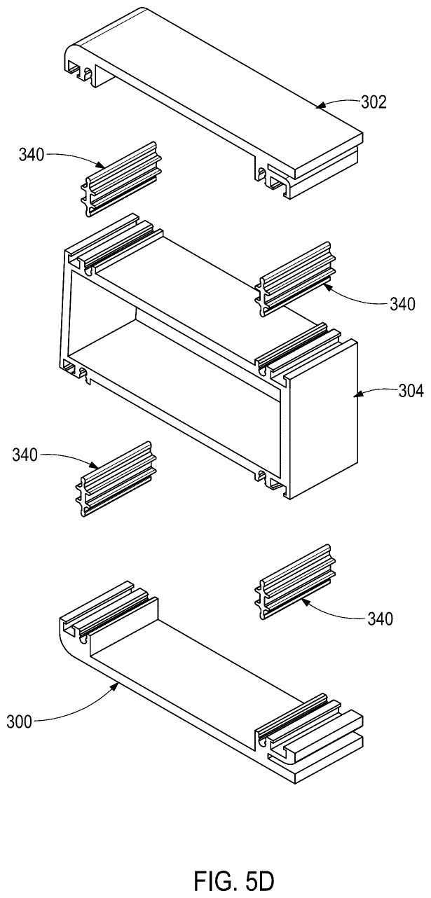

Referring now to FIG. 5, a method 500 of preparing a frame member for a fenestration is provided, according to at least one aspect of the present disclosure. In one aspect, the fenestration comprises a door, such as a swinging or sliding door. In other aspects, the fenestration comprises a window. An example graphical implementation of the method 500 is provided in FIGS. 5A-5C with an exploded view of the frame member after Step 5 of the example implementation provided in FIG. 5D.

The method 500 comprises coupling an interior extrusion to a central extrusion, as at 502. In one aspect, an interior extrusion, such as interior extrusion 302, is coupled to a central extrusion, such as central extrusion 304, using at least one of retainer clips, such as retainer clips 340, and thermal barriers, such as thermal barriers 352.

In some aspects, the interior extrusion is coupled to the central extrusion using retainer clips. In one aspect, first portions of the retainer clips, such as first portions 342 of retainer clips 340, are inserted into clip pockets defined in the interior extrusion, such as clip pockets 318. In addition, the second portions of the retainer clips, such as second portions 344 of retainer clips 340, are aligned with corresponding clip pockets defined in the central extrusion, such as clip pockets 330, 334, and the interior extrusion is pushed toward the central extrusion such that the second portions are forced into and engage with the clip pockets defined in the central extrusion, thereby coupling the interior extrusion to the central extrusion. Alternatively, in one aspect, referring to FIG. 5A, the second portions are inserted into the central extrusion and then the first portions are aligned with and pressed into corresponding clip pockets defined in the interior extrusion.

In some aspects, the interior extrusion is coupled to the central extrusion using thermal barriers. In one aspect, referring to FIG. 5C, after the interior extrusion is coupled to the central extrusion using the retainer clips, the interior extrusion and the central extrusion are oriented such that a pocket, such as pocket 350, defined by a recess in the interior extrusion, such as recess 320, a recess in the central extrusion, such as recess 332, and a body of the retainer clip, such as body 346, are oriented upwardly. A nozzle (not shown) is then used to pour a material into the pocket and the material is allowed to cure, forming the thermal barrier. Additional discussion regarding forming the thermal barrier is described in U.S. Pat. No. 9,068,344, entitled “METHOD FOR INCORPORATING THERMAL BARRIERS INTO TUBULAR EXTRUSIONS USING RETAINER CLIPS”, filed Mar. 12, 2014, which was previously incorporated by reference in its entirety herein.

The method 500 further comprises coupling an exterior extrusion to the central extrusion, as at 504. In one aspect, an exterior extrusion, such as exterior extrusion 300, is coupled to the central extrusion, such as central extrusion 304, using at least one of retainer clips, such as retainer clips 340, and thermal barriers, such as thermal barriers 352. In some aspects, the exterior extrusion is coupled to the central extrusion in a substantially similar manner as the interior extrusion is coupled to the central extrusion, described above. See FIGS. 5B and 5C, for example.

Prior to coupling the interior extrusion and the central extrusion, as at 502, the method 500 optionally includes positioning an insulator between the interior extrusion and the central extrusion, as at 506. For instance, in one aspect, an insulator, such as a first insulator 362, is positioned between an interior surface of the interior extrusion, such as interior surface 308 of interior extrusion 302, and an interior surface of the central extrusion, such as interior surface 324 of central extrusion 304, prior to coupling the interior extrusion to the central extrusion, such as with an adhesive to attach the insulator to at least one of the interior surface of the interior extrusion and the interior surface of the central extrusion.

In some embodiments, prior to coupling the exterior extrusion to the central extrusion, as at 504, the method 500 may optionally include positioning an insulator between the exterior extrusion and the central extrusion, as at 508. For instance, in one aspect, an insulator, such as second insulator 360, is positioned between an interior surface of the exterior extrusion, such as an interior surface 308 of interior extrusion 302, and an exterior surface of the central extrusion, such as exterior surface 322 of central extrusion 304, prior to coupling 504 the exterior extrusion to the central extrusion, such as with an adhesive to attach the insulator to at least one of the interior surface of the exterior extrusion and the exterior surface of the central extrusion.

After coupling the interior extrusion and the central extrusion, as at 502, the method 500 may optionally include positioning an insulator between the interior extrusion and the central extrusion, as at 510. In one aspect, the positioning step 510 is performed in the alternative to the positioning step 506. In some aspects, an insulator, such as second insulator 362, is positioned between an interior surface of the interior extrusion, such as an interior surface 308 of an interior extrusion 302, and an interior surface of the central extrusion, such as an interior surface 324 of a central extrusion 304, after coupling the interior extrusion to the central extrusion, as at 502. In one aspect, positioning the insulator between the interior extrusion and the central extrusion after coupling the same comprises sliding a pre-formed insulator into a gap, such as gap 363, between the interior extrusion and the central extrusion. In one aspect, positioning the insulator between the interior extrusion and the central extrusion after coupling 502 the same comprises spraying an expanding foam into the gap defined between the interior extrusion and the central extrusion. In one aspect, in the alternative to the positioning step 510, the method 500 optionally comprises positioning the insulator between the interior extrusion and the central extrusion, as at 510′, after coupling the exterior extrusion to the central extrusion, as at 504.

After coupling the exterior extrusion and the central extrusion, as at 504, the method 500 may optionally include positioning an insulator between the exterior extrusion and the central extrusion, as at 512. In some aspects, an insulator, such a first insulator 360, is positioned between an interior surface of the exterior extrusion, such as an interior surface 308 of an exterior extrusion 300, and an exterior surface of the central extrusion, such as an exterior surface 322 of a central extrusion 304, after coupling the exterior extrusion to the central extrusion. In one aspect, positioning the insulator between the exterior extrusion and the central extrusion after coupling the same comprises sliding a pre-formed insulator into a gap, such as gap 361, between the exterior extrusion and the central extrusion. In one aspect, positioning the insulator between the exterior extrusion and the central extrusion after coupling the same comprises spraying an expanding foam into the gap defined between the exterior extrusion and the central extrusion.

The foregoing system and assembly provides numerous advantages that will be readily apparent to a person having ordinary skill in the art. For example, the inclusion of the central extrusion 304, as well as the serial thermal breaks (i.e., the retainer clips 340 and thermal barriers 352 between the exterior extrusion 300/interior extrusion 302 and the central extrusion 304) increase the thermal performance of the system 100, thereby further mitigating heat conduction from the exterior extrusion 300 to the interior extrusion 302, and vice versa. Furthermore, the inclusion of the central extrusion 304 mitigates the bi-metallic effect. For example, the central extrusion 304 increases the structural integrity of the frame members (rails 106a,b and stiles 108a,b) when subjected to elevated temperatures that cause bowing of the exterior extrusions 300. Other advantages of the foregoing disclosure will be readily apparent to those having ordinary skill in the art.

Therefore, the disclosed systems and methods are well adapted to attain the ends and advantages mentioned as well as those that are inherent therein. The particular embodiments disclosed above are illustrative only, as the teachings of the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope of the present disclosure. The systems and methods illustratively disclosed herein may suitably be practiced in the absence of any element that is not specifically disclosed herein and/or any optional element disclosed herein.

While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the elements that it introduces. If there is any conflict in the usages of a word or term in this specification and one or more patent or other documents that may be incorporated herein by reference, the definitions that are consistent with this specification should be adopted.

As used herein, the phrase “at least one of” preceding a series of items, with the terms “and” or “or” to separate any of the items, modifies the list as a whole, rather than each member of the list (i.e., each item). The phrase “at least one of” allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The use of directional terms such as above, below, upper, lower, upward, downward, left, right, interior, exterior, and the like are used in relation to the illustrative embodiments as they are depicted in the figures, the upward direction being toward the top of the corresponding figure and the downward direction being toward the bottom of the corresponding figure. However, it will be understood that these terms are used for convenience and ease of description only and are not intended to limit the disclosure to any particular orientation.

What is claimed is:

1. A fenestration, comprising:
a plurality of frame members, at least one of the frame members comprising:
an exterior extrusion;
an interior extrusion;
a central extrusion intermediate the interior extrusion and the exterior extrusion; and
a thermal break to couple the exterior extrusion and the central extrusion.

2. The fenestration of claim 1, wherein the thermal break is a first thermal break and the fenestration further comprises a second thermal break to couple the interior extrusion to the central extrusion.

3. The fenestration of claim 1, wherein the central extrusion comprises a tubular extrusion.

4. The fenestration of claim 1, wherein the exterior extrusion comprises an I-shaped extrusion.

5. The fenestration of claim 1, further comprising an insulator positioned between the exterior extrusion and the central extrusion.

6. A fenestration, comprising:
a plurality of frame members, at least one of the frame members comprising:
an exterior extrusion defining a first clip pocket;
an interior extrusion;
a central extrusion intermediate the interior and exterior extrusions and defining a second clip pocket; and
a clip positionable in the first and second clip pockets to couple the exterior extrusion and the central extrusion and provide a thermal break between the exterior extrusion and the central extrusion.

7. The fenestration of claim 6, wherein the interior extrusion defines a third clip pocket and the central extrusion further defines a fourth clip pocket, wherein the at least one of the frame members further comprises a second clip positionable in the third and the fourth clip pockets to couple the interior extrusion and the central extrusion and provide a thermal break between the exterior extrusion and the central extrusion.

8. The fenestration of claim 6, wherein the central extrusion comprises a tubular extrusion.

9. The fenestration of claim 6, wherein the exterior extrusion comprises an I-shaped extrusion.

10. The fenestration of claim 6, wherein:
the exterior extrusion further defines a first recess;
the central extrusion further defines a second recess;
the first clip defines a body;
the first recess, the second recess, and the body define a pocket based on the exterior extrusion being coupled to the central extrusion via the first clip; and
the at least one of the frame member further comprises a thermal barrier positioned in the pocket.

11. The fenestration of claim 6, wherein the fenestration is a door.

12. The fenestration of claim 6, wherein the fenestration is a window.

13. The fenestration of claim 6, further comprising an insulator positioned between the exterior extrusion and the central extrusion.

14. The fenestration of claim 13, wherein the insulator comprises an insulating foam.

15. The fenestration of claim 13, wherein the insulator comprises polyurethane.

16. A method of preparing a frame member for a fenestration, the method comprising:
coupling an exterior extrusion to a central extrusion by:
positioning a first portion of a first clip into a clip pocket of the exterior extrusion; and
positioning a second portion of the first clip into a first clip pocket of the central extrusion; and
coupling an interior extrusion to the central extrusion by:
positioning a first portion of a second clip into a clip pocket of the interior extrusion; and
positioning a second portion of the second clip into a second clip pocket of the central extrusion.

17. The method of claim 16, further comprising positioning an insulator between the exterior extrusion and the central extrusion.

18. The method of claim 17, wherein positioning the insulator between the exterior extrusion and the central extrusion comprises attaching the insulator to at least one of the exterior extrusion and the central extrusion with an adhesive.

19. The method of claim 17, wherein positioning the insulator between the exterior extrusion and the central extrusion comprises sliding the insulator between the coupled exterior extrusion and central extrusion.

20. The method of claim 17, wherein positioning the insulator between the exterior extrusion and the central extrusion comprises spraying an expanding foam between the coupled exterior extrusion and central extrusion.
